(19) United States
(12) Patent Application Publication
(10) Pub. No.: US 2004/0249659 A1
(43) Pub. Date: Dec. 9, 2004

(54) Procurement framework

(76) Inventors: Sven Schwerin-Wenzel, Dielheim (DE); Eric Wood, Menlo Oaks, CA (US); Nir Kol, Sunnyvale, CA (US); Dennis B. Moore, Burlingame, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/769,472

(22) Filed: Jan. 30, 2004

Related U.S. Application Data
(60) Provisional application No. 60/455,087, filed on Mar. 14, 2003.

(51) Int. Cl. G06F 17/60

(52) U.S. Cl. 705/1

(57) ABSTRACT

Systems and techniques relating to software for enterprise change, in particular to merger and acquisition processes and tools for one or more organizations. A method includes providing a single logical physically distributed information system across one or more information systems of at least two enterprises, wherein the enterprises are being combined, and providing a user interface to access the single logical physically distributed information system to execute one or more pre-merger activities, merger activities, and post-merger activities, wherein the merger activities comprise procurement realignment.

### CROSS REFERENCE TO RELATED APPLICATIONS

This application claims the benefit of priority from U.S. Provisional Application entitled “ENTERPRISE CHANGE PLANNING AND EXECUTION,” filed on Mar. 14, 2003, Application Serial No. 0.60/455,087.

### BACKGROUND

During an organizational restructuring, such as a merger or acquisition, an organization needs to adjust supplier relationships. In order to obtain one or more merger goals, merger organizations may desire to share supplier information and resources. Moreover, merger organizations may want to devise new supplier relationships and reduce procurement costs.

### SUMMARY

The present application describes systems., methods and software for enterprise change, such as mergers & acquisitions (M&As), for one or more organizations.

In an aspect, the invention features a method of facilitating an enterprise change including treating two or more information systems as a single logical information system to execute pre-change due diligence and post-change integration of the enterprise change, the enterprise change including at least one of a merger and an acquisition, and providing a user interface to access the logical information system to manage supplier information and supplier resources.

In embodiments, the method can include providing a procurement user interface to access the logical information system to manage procurement information and resources, and allowing the procurement user interface to present at least one of a synergies panel, a merger risk, a synergy target, and a sub-deliverable, the procurement user interface presenting an impact of a synergy and a risk level impact.

In another aspect, the invention features a method including providing a single logical physically distributed information system across one or more information systems of at least two enterprises, wherein the enterprises are being combined, and providing a user interface to access the single logical physically distributed information system to execute one or more pre-merger activities, merger activities, and post-merger activities, wherein the merger activities can include procurement realignment.

In embodiments, the user interface can be adapted to at least one of a role of the user and a phase of the merger, wherein the user role can include a procurement stakeholder, an internal expert, and an external expert of one of the enterprises.

In another aspect, the invention features a system for planning a merger of at least two organizations, the system including a clean room object and a module to consolidate suppliers of at least one of the organizations, the system further including a list of consolidated items, the list including a lowest negotiated supplier price and a resulting post-merger cost savings.

In embodiments, the system can include at least one of a list of consolidated items with volume information and a list of consolidated suppliers with volume information, at least one of the lists presenting a percent change in volume.

In another aspect, the invention features a system for planning a merger of at least two organizations, the system including a process adapted to allow one or more merger members to access procurement information, the process including a user interface adapted to allow a user to search for stakeholders, a deliverables view, and a financial impact of obtaining one or more goods from a supplier.

In embodiments the process can include a planned timeline and a risk level, the process presenting merger financial information, the financial information including a budget and a return on investment, the deliverables view including one or more sub-deliverables, the system further including one or more procurement-related messages, the messages including supplier contract information.

In another aspect, the invention features a method including facilitating consolidation of suppliers for an organization in a merger of at least two organizations, facilitating an assessment of supplier information of at least one of the organizations, and presenting a user interface adapted to facilitate the consolidation of the suppliers and facilitate the assessment of supplier information, the user interface including personalized tasks.

In another aspect, the invention features a system for planning a merger of at least two organizations including a procurement synergy, a procurement initiative item related to the procurement synergy, and an attachment related to the item, the attachment being a supply-related clean-room object.

In another aspect, the invention features a system for implementing a merger of at least two organizations, wherein the system can include a first user interface adapted for a procurement stakeholder for a first organization, and a second user interface adapted for a procurement stakeholder for a second organization, the second user interface facilitating sharing of one or more procurement objects with the first user interface.

In embodiments, the at least one of the interfaces presents contact information for at least one procurement stakeholder of one of the organizations, the system further including a synergy item.

In another aspect, the invention features a system for planning a merger of at least two organizations, the system including information repositories, a clean room, and an interface adapted to present research information, the research information including one or more lists of legal, accounting, commercial, and internal data.

In embodiments, the system can include at least one of information on suppliers and customers, supplier contracts, customer lists, procurement item lists, credit terms for one or more supplier, supplier prices, and sample procurement reports. The system can also include a supplier contract document.

### BRIEF DESCRIPTION OF THE DRAWINGS

These and other aspects will now be described in detail with reference to the following drawings.

FIG. 1 is a block diagram of a system.

FIG. 2 is a flow diagram.

FIG. 3 is a block diagram of an architecture.

FIG. 4 is a block diagram of a platform.

FIGS. 5-16 illustrate exemplary user interfaces.

Like reference symbols in the various drawings indicate like elements.

### DETAILED DESCRIPTION

The systems and techniques described here relate to software for organizations in a restructuring environment, such as doing a merger and acquisition (M&A).

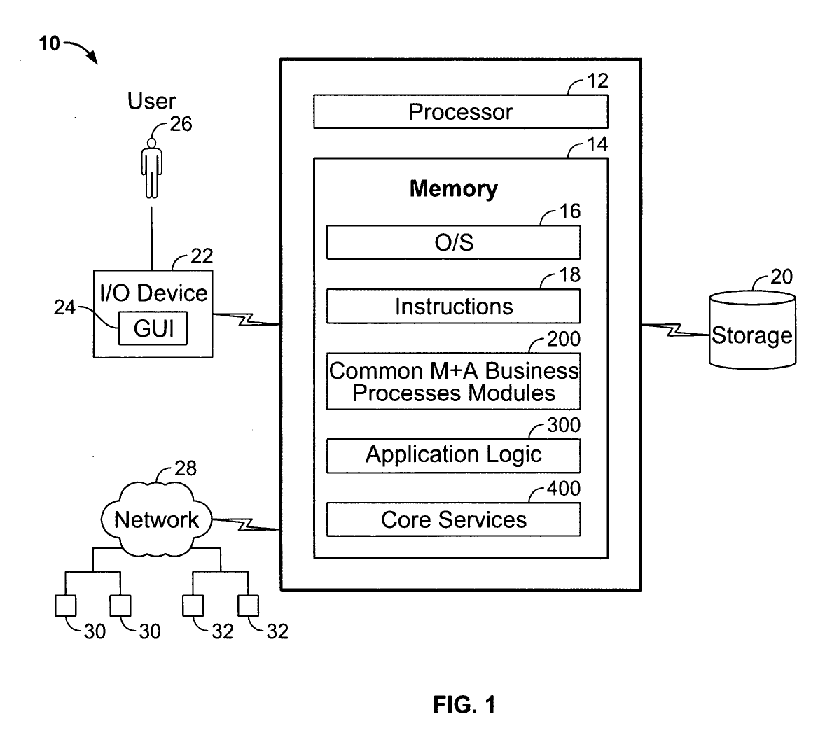

As shown in FIG. 1, a system 10 includes a processor 12 and a memory 14. Memory 14 includes an operating system 16, and instructions 18, that when executed by the processor 12, perform an exemplary restructuring integration process 100, described below. A specific restructuring process, referred to as a merger and acquisition (M&A), will be used as an example throughout this description. However, the process 100 can be applied to most corporate change or restructuring activities, such as spin-offs, department mergers and splits, and so forth. Memory 14 also includes common restructuring business processes modules 200, application logic 300, and a core framework of services 400 that support the restructuring integration process 100. The system 10 includes a link to a storage device 20 and an input/output device 22. The input/output device 22 can include a graphical user interface (GUI) 24 for display to a user 26.

The system 10 includes a link to a network 28. Network 28 links the system 10 to other systems 30 within a single entity and to systems 32 in one or more other entities. Systems 30, 32, generally referred to as clients or source systems, access data through a portal 34. Systems 10, 30, 32 are designed to act as a single logical physically distributed information system representing multiple enterprise information systems of organizations residing in the systems 30, 32. Information is exchanged between the system 10 and systems 30, 32 through the portal 34 and through user interfaces (UIs) of an architecture, described below.

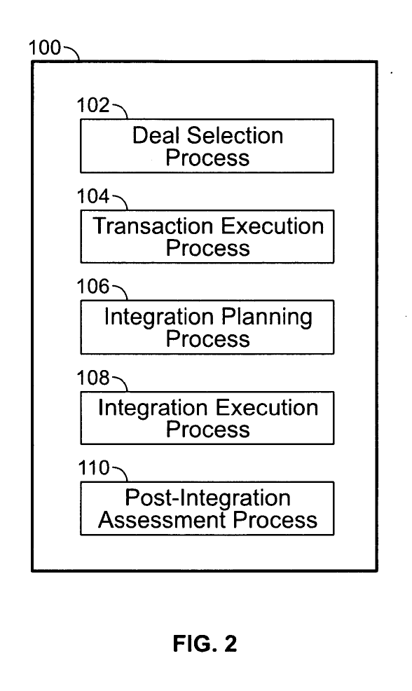

As shown in FIG. 2, the restructuring integration process 100 includes a deal selection process 102. The deal selection process 102 defines acquisition objectives and strategies. The deal selection process 102 searches for the best fit target company to meet a set of objectives and manages detailed due diligence on the target company. The deal selection process 102 also identifies synergies, risks and a realization plan for acquiring the target company.

A transaction execution process 104 structures an acquisition in terms of type, tax implications, legal issues and so forth. The transaction execution process 104 closes an acquisition deal and provides for a rollback in the event the acquisition deal fails.

An integration planning process 106 provides a plan for short term and long term tasks of acquisition integration and communicates goals and decisions to all stakeholders.

The restructuring integration process 100 includes an integration execution process 108. The integration execution process 108 manages an integration project and it sub-projects, designs a new organization, and minimizes disruptions to customers by rolling out combined field organizations quickly.

The integration execution process 108 manages the integration of information technology (IT), human resources (HR), financials and procurement. The integration execution process 108 provides for the retention of key employees, manages field organization integration, and identifies cross-selling opportunities and rolls the opportunities out. The integration execution process 108 manages stakeholders, tracks an acquisition, and reports issues and successes.

The restructuring integration process 100 includes a post-integration assessment process 110. The post-integration assessment process 110 measures achieved synergies against targets, accesses where improvements can be made in synergy estimation and/or in integration execution, and applies history to a next transaction.

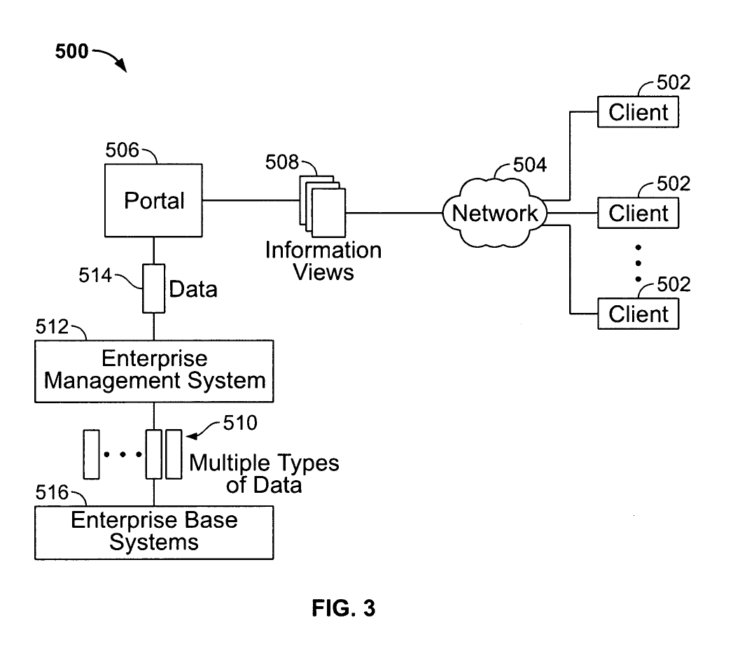

As shown in FIG. 3, the restructuring integration process 100, common restructuring business processes modules 200, application logic 300, and core framework of services 400 are designed to conform to an architecture 500 designed to a platform 600 that represents a single logical physically distributed information system representing multiple enterprise information systems of organizations. The architecture 500/platform 600 insure consistency of data exchange between system 10 and source systems 30, 32, and a separation of source systems 30, 32, when appropriate during phases of the restructuring integration process 100.

The single logical physically distributed information system architecture 500 representing multiple enterprise information systems of organizations includes multiple clients 502 accessing data over a network 504 through a portal 506. In one embodiment, the clients 502 are processes and/or web browsers that are coupled to the network 504 through a proxy server (not shown).

The portal 506 provides a common interface to program management services through user interface (UI) components 508.

The portal 506 receives requests from the clients 502 and generates information views (iViews) 510, such as web pages, in response. In embodiments, the portal 506 implements a user roles-based system to personalize a common interface and the iViews 510 for a user of one of the clients 502. The user can have one or more associated roles that allow personalized tailoring of a presented interface through the iViews 510.

The portal 506 communicates with an enterprise management system 512 that consolidates multiple application services. The portal 506 receives data 514 from the system 512 to fulfill the requests of the clients 502. The system 512 provides integrated application services to manage business objects and processes in a business enterprise. The business objects and processes include resources such as personnel, development projects, business programs, inventories, clients, accounts, business products, business services and so forth.

The system 512 communicates with enterprise base systems 516 to obtain multiple types of enterprise base system data 518. The base systems 516 include application services, such as human resource management systems, customer relationship management services, financial management systems, project management systems, knowledge management systems, business warehouse systems, time management systems, electronic file systems and mail systems. In embodiments, the enterprise base systems 516 include a single integration tool, such as exchange from SAP AG of Germany, which provides an additional level of integration among the enterprise base systems 516. The enterprise management system 512 consolidates and integrates data and functionality of the enterprise base systems 516 into the single management tool.

The single management tool includes systems and methods to facilitate generation of new applications within the enterprise management system 512. The new applications, generally referred to as cross-functional or composite applications, draw on resources of the enterprise base systems 516 to cross over traditional application boundaries and handle new business scenarios in a flexible and dynamic manner.

A virtual business cycle can be generated using such composite applications, where executive level business strategy can feed management level operational planning, which in turn can feed employee level execution, which can feed management level evaluation, which can feed executive level enterprise strategy. Information generated in each of these stages in an enterprise management cycle can be consolidated and presented by the enterprise management system 512 using the customized cross-functional applications. The stages provide and consume determined services that are integrated across multiple disparate platforms.

The portal 506, enterprise management system 512 and enterprise base systems 516 can reside on one or more programmable machines, which communicate over the network 504 or one or more communication busses. In embodiments, the base systems 516 reside in multiple servers connected to the network 504, and the portal 506 and enterprise management system 512 reside in a server connected to a public network (not shown). Thus, the architecture 500 can include customized, web-based, cross-functional applications, and a user can access and manage enterprise programs and resources using these customized web-based, cross-functional applications from anywhere that access to the public network is available.

A user interface (UI) provides UI patterns used to link new objects and workflow together and generate standardized views into results generated by one or more cross-functional applications.

An object modeling tool enables generation of new business objects in a persistency/repository layer by providing a mechanism to extend a data object model dynamically according to the needs of an enterprise.

A process modeling tool enables generation of new business workflow and ad hoc collaborative workflow. The process modeling tool includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure is trackable by a process owner or by involved contributors using a “dashboard” that displays highly aggregated data. The dashboard and a “myOngoingWork place” can be two UI patterns that are provided by the UI components 508.

Whenever there is a concept of “myObjects,” “myRecentObjects,” “myRelatedObjects” or “myPreferredObjects,” then an object picker UI pattern, provided by the UI components 508, is included that lets users pick their favorite object directly. Whenever people are to be searched, either for choosing one individual person or for generating a collection of people meeting some criterion, a “People Finder” concept can be applied. A key aspect of searching for a person is described as an attribute within the user's activity, qualification, interest, and collaboration profile. For a given cross-functional application, people collections can be stored as personal or shared collections using the People Finder to make them available for further operations later on. Whenever there is a strategic view on a cross-functional application scenario, analytics of the overall portfolio can be made available in the form of a collection of the UI components 508. A view selector is used to display/hide components, and a component can be toggled between graphical and numerical display and include a drop-down list or menu to select sub-categories or different views.

Cross-functional application scenarios provide related information to the user when possible, and some parts within a larger cross-functional application define what kind of related information is to be offered. Heuristics can be used to identify such relatedness, such as follows: (1) information that is related to the user due to explicit collaborative relationships, such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set) (5) instances of the same object class; (6) next abstract or next detailed class; (7) explicit relationships on the organizational or project structure; (8) proximity on the time scale; (9) information about the underlying business context; and/or (10) information about the people involved in a collaborative process.

Cross-functional applications also can include generic functionality in the form of “Control Center Pages” that represent generic personal resources for each user. These cross-functional applications can refer to the following pages, where appropriate: (1) A “MyOngoingWork” page that provides instant access to all dashboards that let users track their ongoing work. Ongoing work refers to the state of business objects as well as guided procedures. (2) A “MyDay” page that lists today's time based events that are assigned or related to the user. (3) “MyMessageCenter” page that displays all pushed messages and work triggers using a universal inbox paradigm with user selected categorical filters. (4) “MyInfo” that provides access to all personal information collections (documents, business objects, contacts) including those located in shared folders of teams and communities of which the user is a member. MyInfo can also provide targeted search in collaborative information spaces such as team rooms, department home pages, project resource pages, community sites, and/or personal guru pages.

The object modeling tool, process modeling tool and user interfaces are used to build components of cross-functional applications to implement new enterprise management functions without requiring detail coding development by a system architect or programmer.

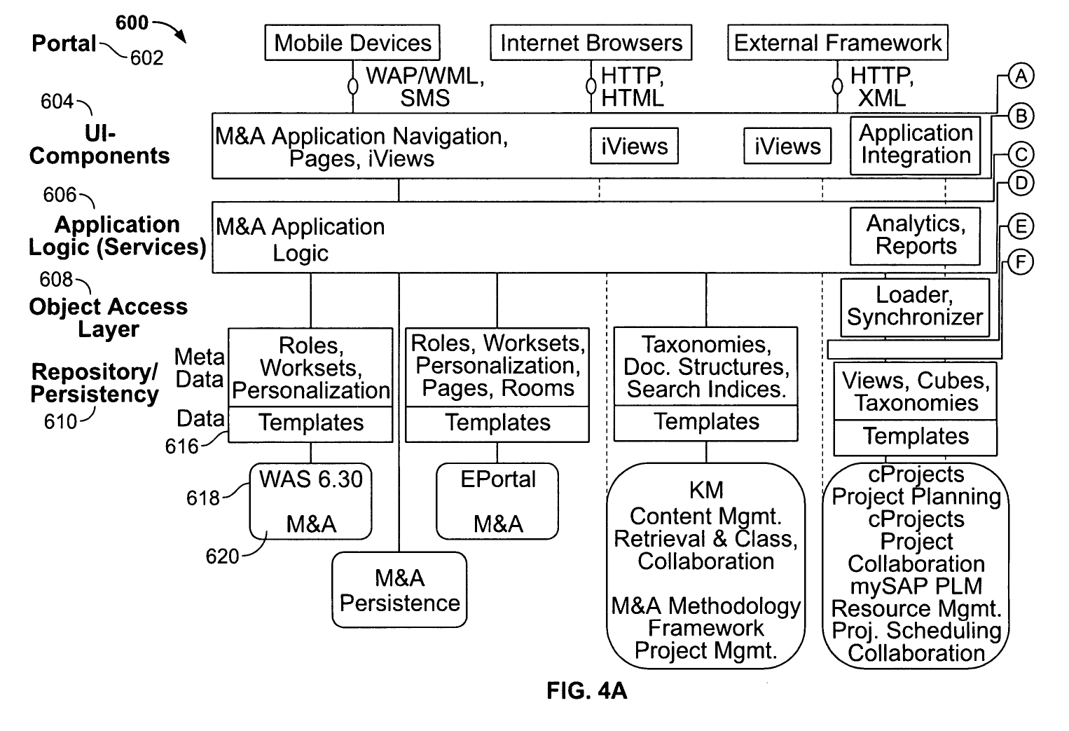

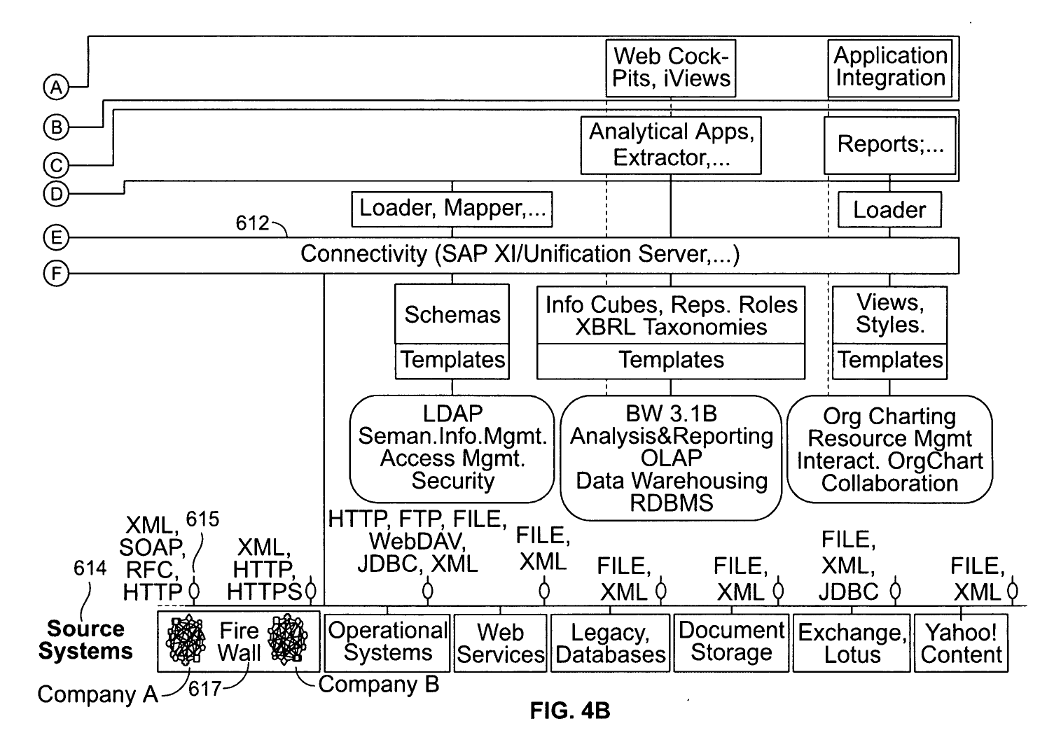

As shown in FIG. 4, a platform 600 that supports the architecture 500 includes a portal 602, user interface (UI) components 604 and application services logic 606. The platform 600 includes an object access layer 608, a persistence/repository layer 610, connectivity layer 612, and source systems 614. In embodiments, the architecture includes software and components from SAP AG of Germany, as well as special corporate restructuring modules.

Graphical user interfaces (GUIs) provide interaction between a user and the UI components 604 through the portal 602. The UI components 604 interact with the application services logic 606. The application services logic 606 interact with databases and repositories in the persistence/repository layer 610. The user requests information via a GUI through the portal 602. The application services logic 606 processes the user request, retrieves the appropriate requested information from the databases and repositories in the persistence/repository layer 610, and sends the requested information to GUI for display to the user.

The databases and repositories in the persistence/repository layer 610 can contain metadata. Metadata refers to data that describes other data, such as data pertaining to roles, work sets and personalization information, for example. The metadata can interact with the object access layer 608, connectivity layer 612 and application services logic 606. The metadata can also interact with templates 616. The templates 616 provide a format or organization of information according to preset conditions. The templates 616 can interface with Web application server (WAS) processes 618 and core merger processes 620 in the repository layer 610.

In embodiments, the databases and repositories in the persistence/repository layer 610 interact with the source systems 614 through base system connectors 615 using a markup language such as extensible markup language (XML), web services such as Simple Object Access Protocol (SOAP), request for comments (RPC), or Transmission Control Protocol/Internet Protocol (TCP/IP). The source systems of one organization can interact with the source systems of another organization through a firewall 617.

The base system connectors 615 can include a enterprise connector (BC) interface, Internet communication manager/Internet communications framework (ICM/ICF), an encapsulated postscript (EPS) interface and/or other interfaces that provide remote function call (RFC) capability. The persistence/repository layer 610 provides the platform 600 with its own database and data object model. The database and data object model provides a consolidated knowledge base to support multiple enterprise functions, including functions generated as cross-applications. Active communication between the persistence/repository layer 610 and the base systems 516/614 provides a linkage between real time relational data from multiple base systems 516/614 and an integrated enterprise tool to permit strategic enterprise management and planning.

The data object model represents a subset of data objects managed by base systems 516/614. Not all of the data aspects tracked in the base systems 516/614 need to be recorded in the data object model. The data object model has defined relationships with data objects stored in the base systems 516/614. For example, certain data objects in the data object model have “read-only” or “write-only” relationships with data objects in the base systems 516/614. These types of defined relationships are enforced through a communication process between the persistence/repository layer 610 and the base systems 516/614. The persistence/repository layer 610 decouples application development from the underlying base systems 516/614.

In embodiments, the source systems 516/614 interact with third party applications, such as Lotus software from IBM or data provided by other content providers, such as Yahoo! As described above, the portal 602 provides a common interface to management services. The management services include a merger project management service and a merger integration project management service. The network 504 links the clients 502 to the portal 602 for exchange of information pertaining to a merger of two organization organizations or an acquisition involving two organizations.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

As used herein, the terms “electronic document” and “document” mean a set of electronic data, including both electronic data stored in a file and electronic data received over a network.

The term “organization” can refer to a company, enterprise, business, government, educational institution, or the like. The term “organization” can also refer to a group of persons, such as an association or society.

An “enterprise change” or “organization change” can refer to a merger, an acquisition, a combination of a merger and acquisition or some other type of change in an organization's structure, leadership, governance, personnel, business, direction, purpose, strategy, and so forth.

A “synergy” can be a value, performance or effect that can be achieved as resources of two organizations combined will be greater than the sum of the separate individual resources. The term “synergy” can also refer to cooperative interaction among groups, especially among the acquired subsidiaries or merged parts of an organization, which generates an enhanced combined effect.

The term “object” can refer to information sources such as documents, reports, presentations, files and directories. A “template” is an interface that can include parameters or a format from a previous merger, or can be transferred or copied from another employee in the same organization or a customer.

The disclosed merger software, among other functions, can offer an object management tool in the pre-merger due diligence process and provide accurate information hand-over to a next phase of the merger process. The “next phase” of the merger process can be the next goal or milestone for the same person or group or it could involve transferring the accumulated merger information to another person or group.

“Stakeholders” are exemplary merger members described herein with an interest or stake in the progress of the merger, or persons who are involved in some aspect of the merger or its effects.

“Strategy” users can include executives or steering committee members who assign and monitor one or more transactions.

“Management” users can include corporate development team members or merger integration team members who are responsible for executing various aspects of the merger. Employee users can include one or more employees who are impacted by the merger.

A “deliverable” can be referred to as a “task” that one or more stakeholders can be responsible for producing for other stakeholders. A deliverable can be referred to as a goal, objective, result or procedure that can be fulfilled, promised, achieved, produced or expected. A deliverable can also be referred to as a merger-related project.

“Due diligence” can involve investigation and examination into one or more details of a potential investment, such as an examination of operations and management and a verification of material facts. Due diligence can serve to confirm material facts regarding a merger or offer, such as reviewing financial records and other items deemed material to the merger.

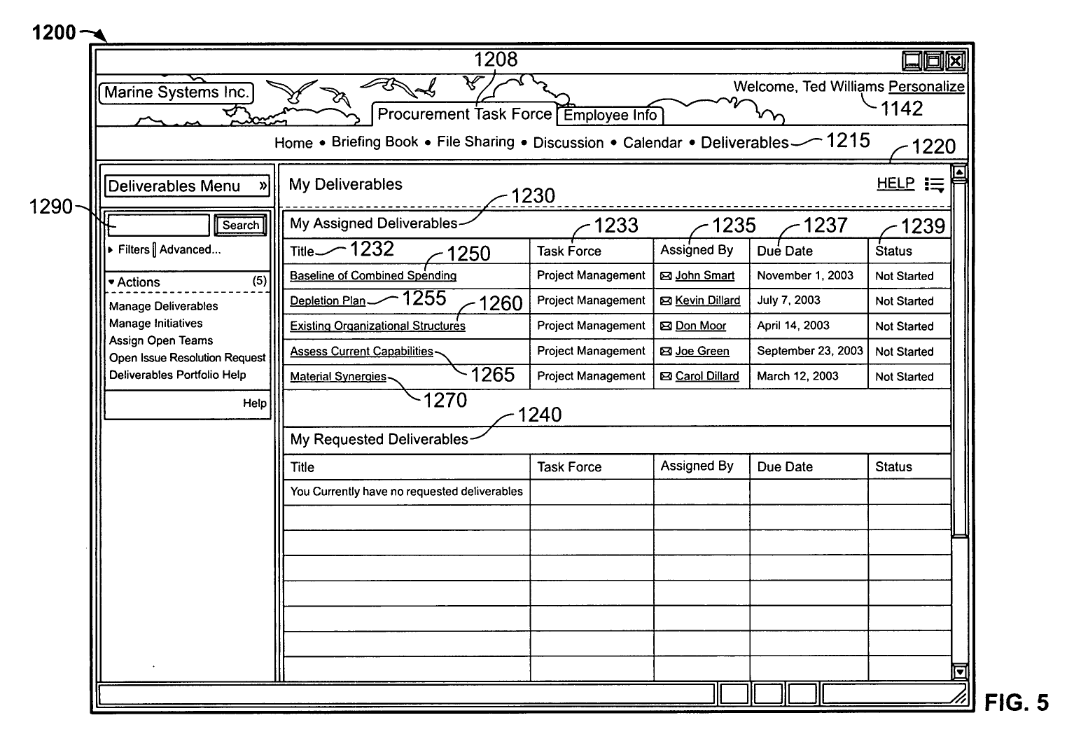

FIG. 5 shows an exemplary interface 1200 with a procurement task force tab 1208 that has a menu of views including a deliverables view 1215. The interface 1200 includes a panel 1220 with personalized assigned deliverables 1230 and requested deliverables 1150. Some deliverable topics 1232 can include a baseline of combined spending 1250, a depletion plan 1255, an organizational structure 1260, a view of current capabilities 1265, and a view of material synergies 1270. In addition to presenting deliverable topics 1232, the panel 1220 can present a targeted merger task force 1233, an initiating deliverable contact person 1235, a deadline 1237, and a status 1239. A user 1142 can select to perform a search of merger information in a search text box 1290.

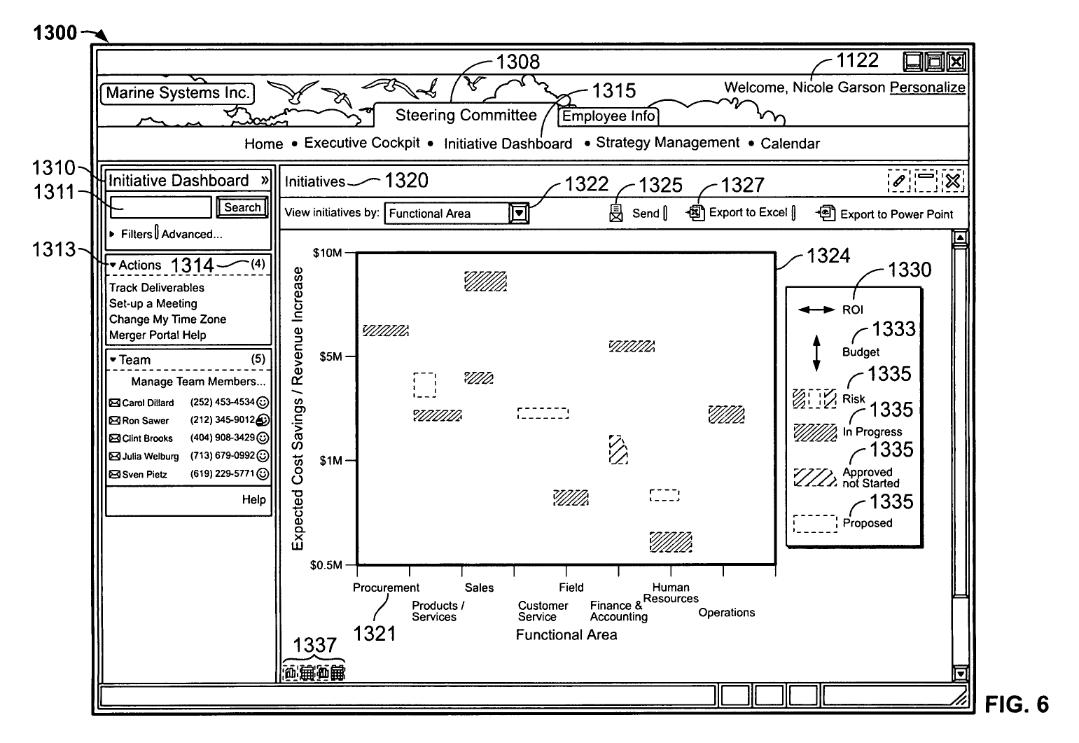

FIG. 6 illustrates an interface 1300 for an initiative dashboard 1315 in a steering committee menu 1308. An initiative panel 1320 allows a user to view a graph 1324 of initiatives. The panel 1320 includes procurement information 1321. A selector 1322 shows an initiative graph 1324 by functional area, cost savings, revenue increase, or other initiative options. The panel 1320 shows a graph legend 1335 with different types and statuses of merger information. The graph 1324 can present merger financial information for a functional area, such as a return on investment 1330 or a budget 1333.

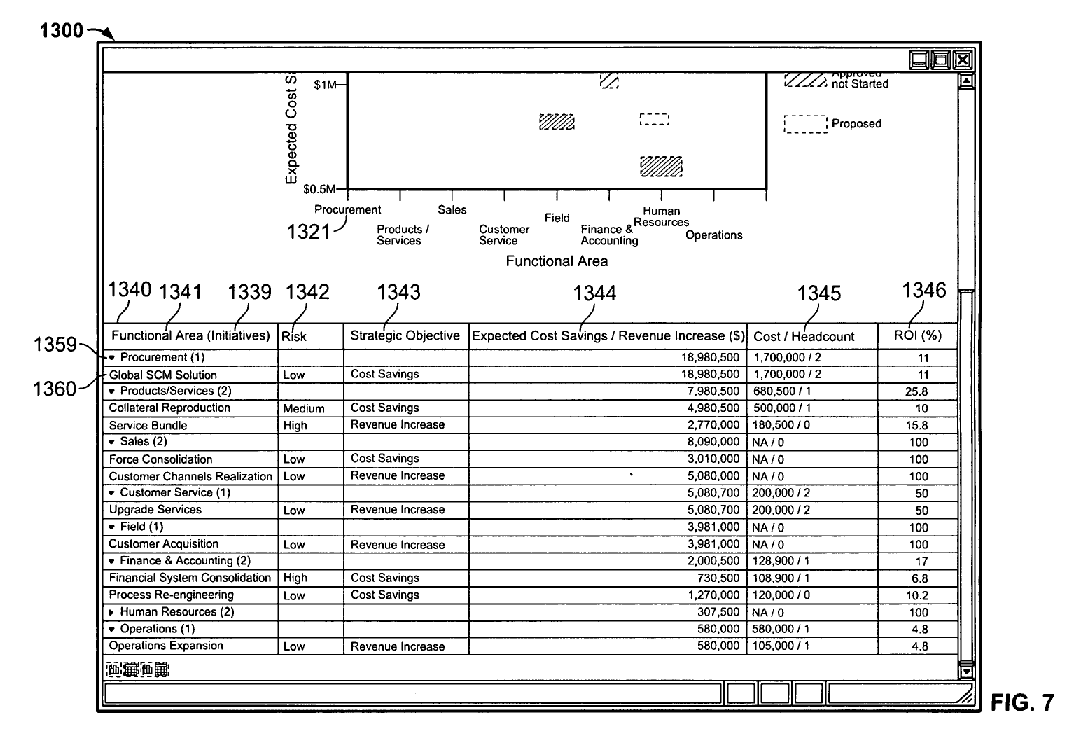

A user 1122 can send the initiative information, such as graph 1324, to other stakeholders via an icon 1325 or transfer the information to an external software object, such as an Excel spreadsheet by Microsoft Corporation via an icon 1327 The interface 1300 allows a user to access a graph 1324, a list (shown in FIG. 7), or a graph and a list of initiative information via icons 1337. Furthermore, the interface 1300 can have a panel 1310 with a text box 1311 to allow the user 1122 to search for items or people, as well as to perform a number 1314 of other actions 1313.

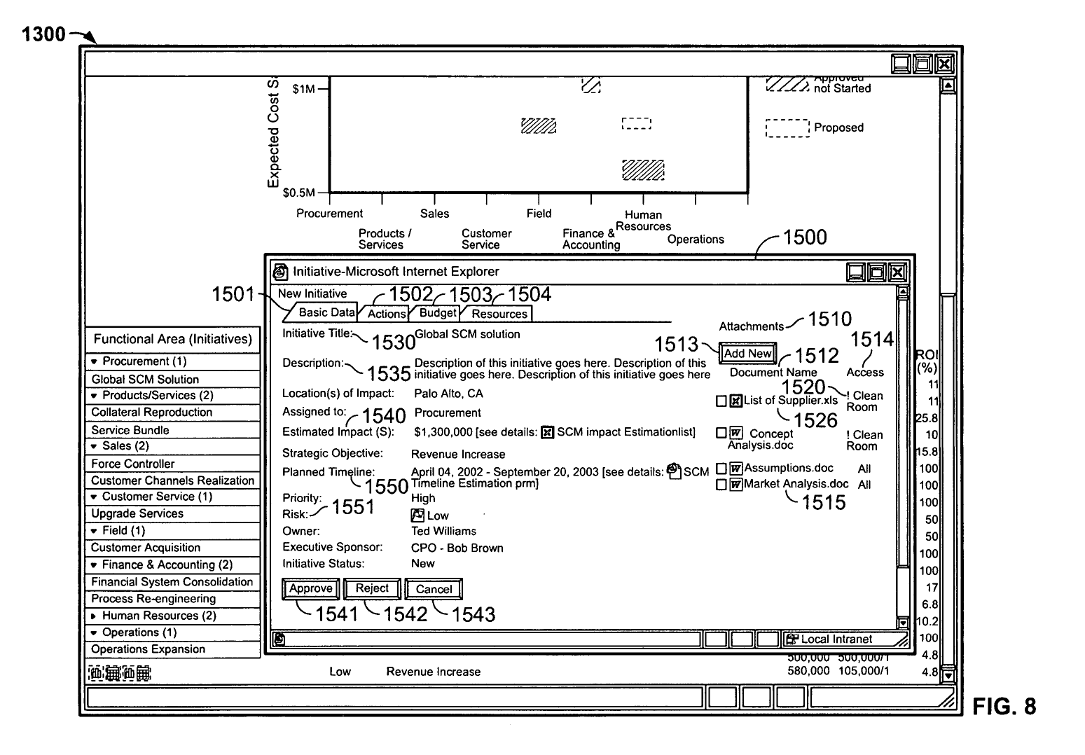

The interface 1300 includes a panel 1340 (FIG. 7) that presents information from the initiative graph 1324 in a list or table format. The panel 1340 presents a functional area 1341 for a number of initiatives 1339. An initiative risk level 1342, a strategic objective 1343, and an expected cost savings 1344 can also be presented. Additionally, a return on investment 1346 and a cost per headcount 1345 can be shown for listed initiatives. A user selects an initiative item 1360, under a procurement heading 1359, to view another panel, as shown in panel 1500 in FIG. 8.

Referring now to FIG. 8, the panel 1500 includes detailed initiative information for the procurement initiative item 1360. The panel 1500 presents tab menus of basic data 1501, actions 1502, budget 1503, and resources 1504. The initiative 1360 in FIG. 8 can be presented with a heading 1530 and a detailed description 1535. Additionally, details of an estimated impact 1540 of the merger initiative 1530 are presented, including a planned timeline 1550 and a risk level 1551. After analyzing the procurement initiative information 1501, the user 1122 can approve, reject or cancel the initiative 1530 via buttons 1541, 1542, 1543.

The user 1122 can view and add attachments 1510 of objects 1515 to the panel 1500 via button 1513. An exemplary attachment 1510 for the procurement initiative item 1360 includes information regarding a list of suppliers 1526. The panel presents the name 1512 of an object 1515 and the level of access 1514 a user 1122 has to the object 1515.

The panel 1500 can include a tool to model a “clean room” environment 1520 during the merger process. The clean room concept during a merger typically includes members of the involved organizations physically meeting in a room and exchanging information and objects. Only the members of a clean room environment can view and examine the confidential and privileged information of other merger organizations. If the merger deal is unsuccessful and the merger deal fails, then the clean room members usually leave their organization for reasons of conflicts of interest, or are transferred to other parts of their organization where they will not be interacting with the other merger organizations.

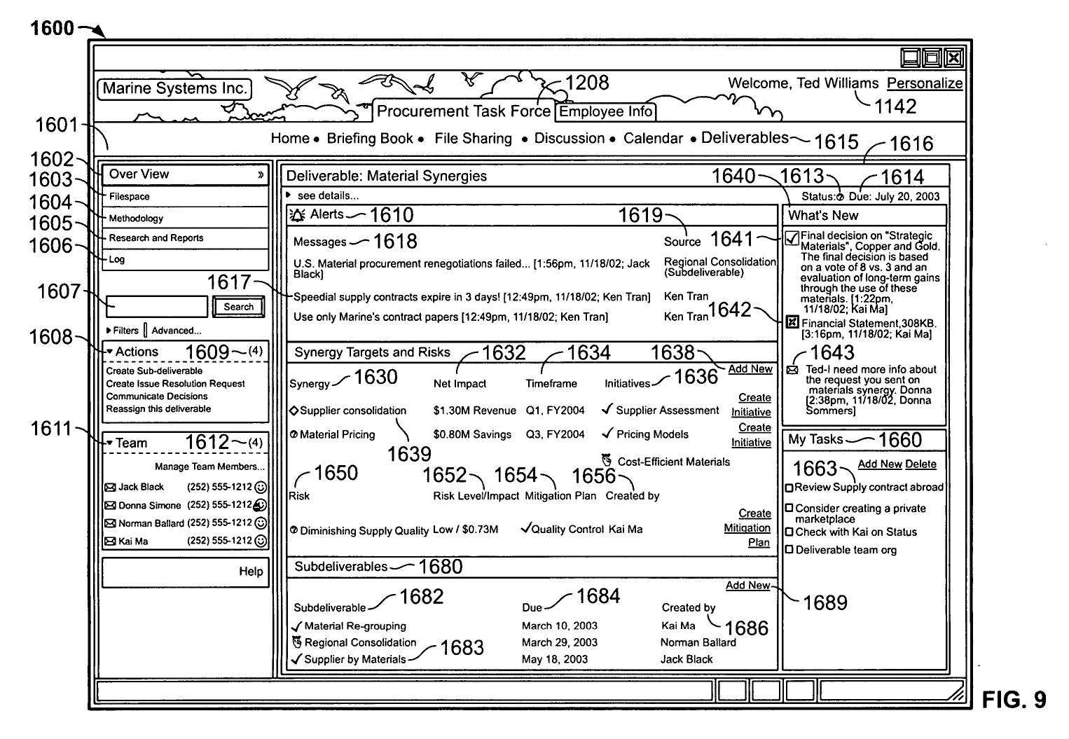

FIG. 9 shows an exemplary interface 1600 with a procurement task force tab 1208 that has a menu of views including a deliverables view 1615. The interface 1600 includes a variety of supply-related information and resources. A user 1142 views a synergies panel 1616 with an alerts section 1610, a synergy targets and risks section 1620, and a sub-deliverables section 1680. In the alert section 1610, the user 1142 can inspect procurement-related messages 1618, along with a message source 1619. For instance, a message 1618 can contain supplier contract notices 1617. The user 1142 can view a net impact 1632 of a synergy 1630 supporting an initiative 1636, such as supplier assessment, in a given time frame 1634. The user 1142 can also evaluate a risk level impact 1652 of a merger risk 1650, such as diminishing supply quality, from a plan 1654 generated by a stakeholder listed in column 1656.

The sub-deliverables section 1680 presents a group of sub-deliverables 1682 with corresponding deadlines 1684 and owners 1686. An exemplary sub-deliverable 1680 is a checklist of suppliers 1683, which can be sorted by materials. The interface 1600 facilitates supplier consolidation 1639 and supplier assessment 1637. The user 1142 can add other synergies 1630, risks 1620 and sub-deliverables 1680 to the panel 1616 via links 1638, 1689.

The interface 1600 presents a general status indicator 1613 and a due date 1614. Another panel 1640 shows recent news, emails 1643, checklists 1641, and objects 1642. Additionally, panel 1660 shows one or more personalized tasks, such as a supply contract review 1663.

Another panel 1601 in the interface 1600 presents a user 1142 with access to several other views, including a file space view 1603, a methodology view 1604, a view of research and reports 1605, and a view of a merger log 1606. The panel 1601 can include a link (not shown) to access human resource-related synergy tools. The panel 1601 can also have search capabilities 1607 and links to a number 1609 of actions 1608. Moreover, a user 1142 can use the presented contact information to contact a number 1612 of other procurement team members 1611.

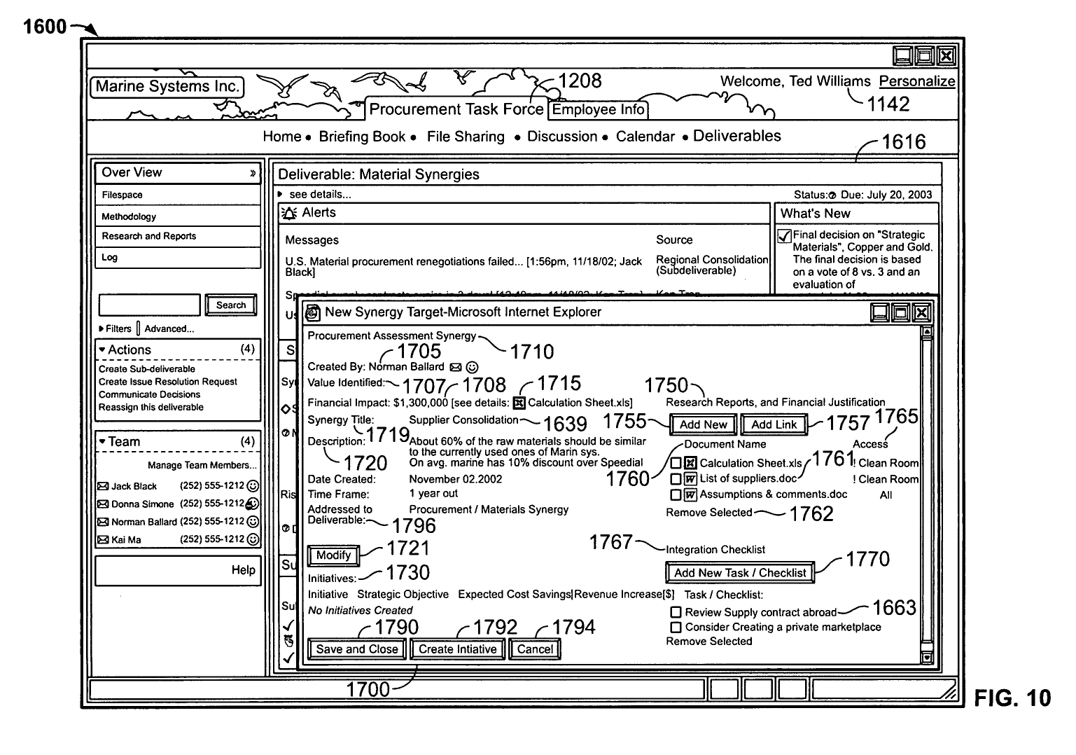

A user 1142 selects a synergy item 1630, such as supplier consolidation 1639, to access another interface 1700 in FIG. 10 of detailed procurement synergy information. FIG. 10 shows interface 1700 for a synergy category (e.g., procurement assessment) 1710 and synergy (e.g., supplier consolidation) 1639 created by a stakeholder 1705. The interface 1700 shows an identified value 1707 from a synergy 1710, such as a financial impact 1708 and any related attachments 1715. The identified value 1707 shows a particular synergy title 1719 and a description summary 1720. The user 1142 can modify the identified value 1707 via button 1721 and create merger-related initiatives 1730.

The interface 1700 also includes a list of objects 1750 that justifies the synergy 1710 with research, reports, and financial information. For example, the object list 1750 includes a list of suppliers 1761. The user 1142 adds an object or a link to the list 1750 via buttons 1755 and 1757, or even removes a listed item via link 1762. The list 1750 can identify a particular level of user access 1765 to an object. The access level 1765 can include a clean room level of access.

The user 1142 is allowed to properly checklist integration issues 1767. For example, a checklist issue 1767 can be a review of supply contracts 1663. The user 1142 can add tasks via button 1770 to ensure proper integration of the procurement synergy 1639. The user 1142 can also generate a new initiative via button 1792, cancel the synergy via button 1794, or save synergy information and close the interface 1700 via button 1790.

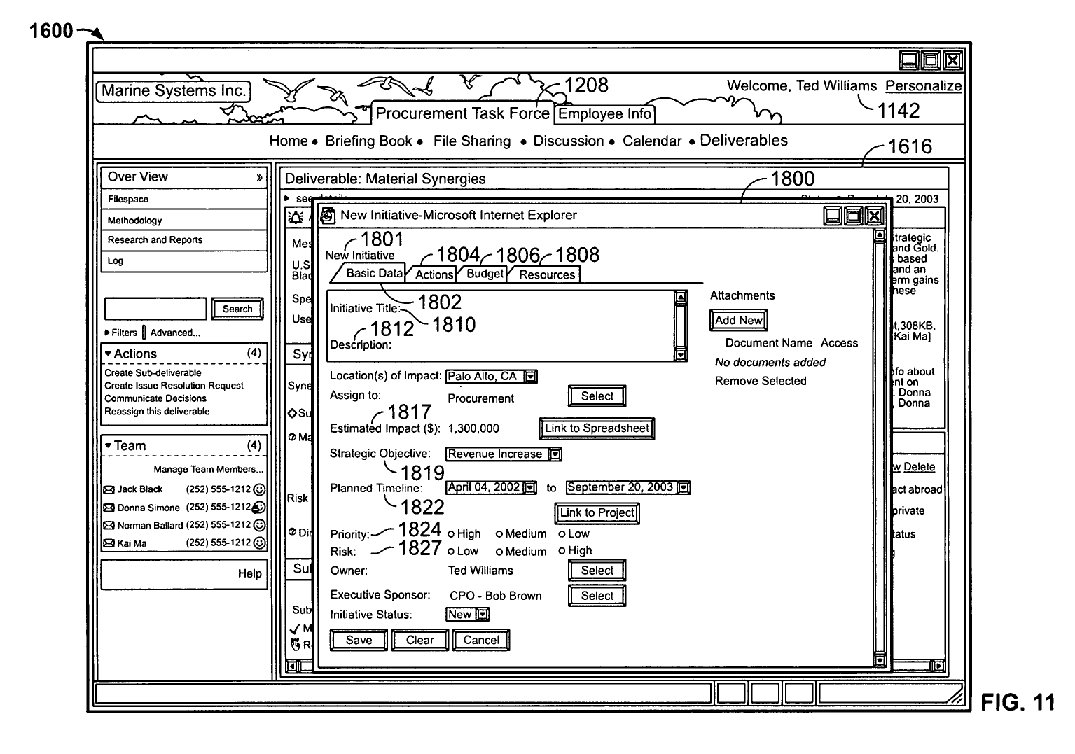

The user 1142 can generate a new initiative 1730 from the button 1792 in FIG. 10 or from the link 1651 in FIG. 9. The new initiative panel 1800 in FIG. 11 resembles the initiative panel 1500 in FIG. 8, but the panel 1800 allows a user to generate initiative information. In general, the panel 1800 allows a user 1142 to enter detailed initiative information. The panel 1800 presents tab menus of basic data 1802, actions 1804, budget 1806, and resources 1808. The user 1142 enters an initiative title 1810 and description 1812. The user 1142 can enter an estimated impact 1817, a strategic objective 1819, and a planned timeline 1822. Moreover, the user 1142 can enter a priority level 1824 and a risk level 1827.

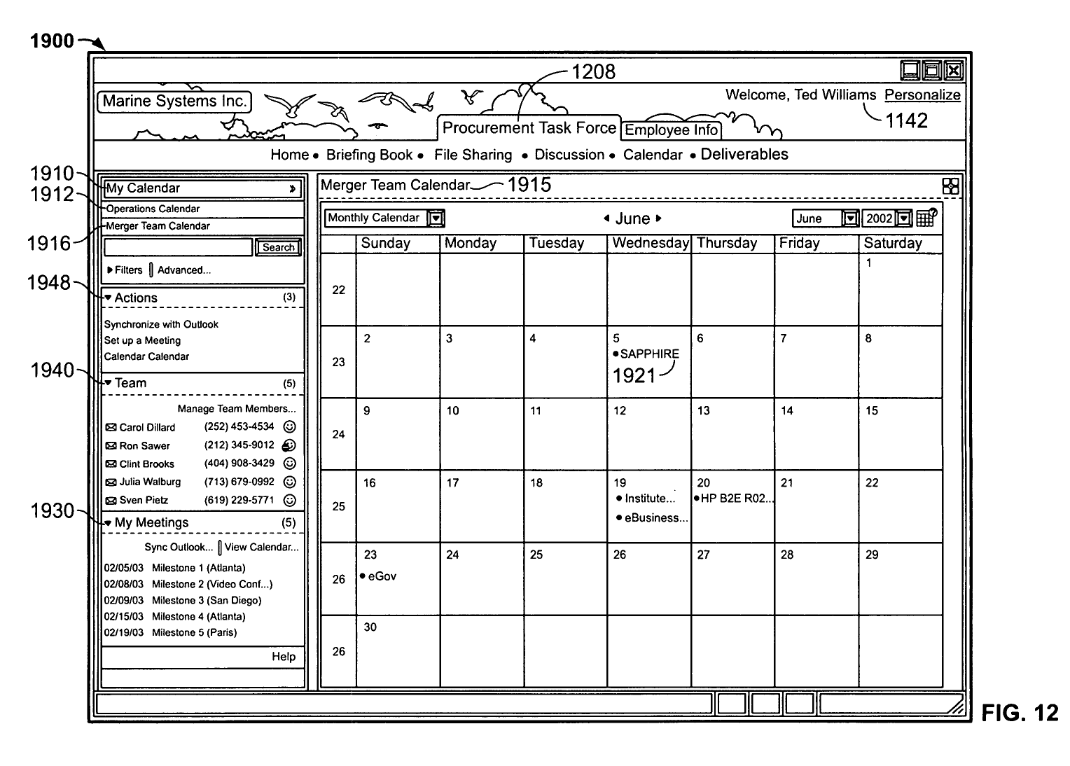

FIG. 12 shows an example of a calendar interface 1900 for the procurement task force 1940. The calendar interface 1900 can have an event 1921 that can be scheduled by a user 1142 or a member of a procurement task force 1940. The user 1142 can also collaborate with a calendar 1912 of another merger group. The user 1142 can access a personal calendar 1910 to incorporate all of the events from each calendar in which the user 1142 has access. The personal calendar (not shown) also can store and present personal user events and meetings 1930. Furthermore, the user 1142 can perform a number 1949 of actions 1948 in the calendar interface 1900.

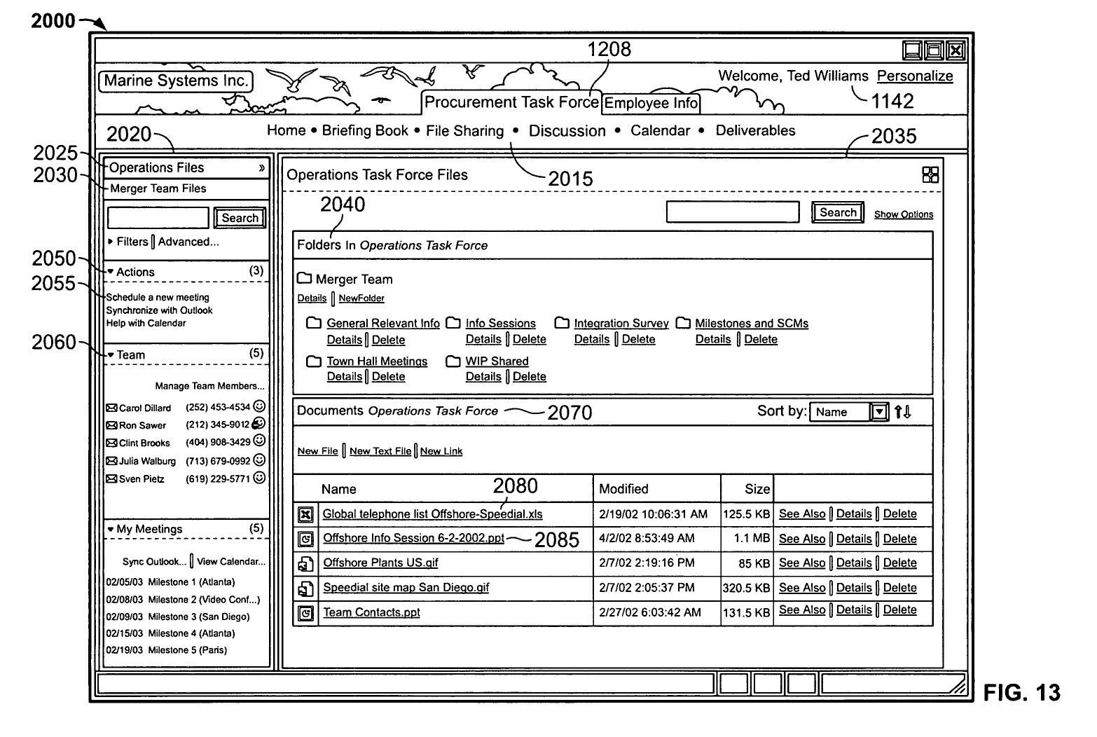

FIG. 13 illustrates an interface 2000 that allows stakeholders from various groups to collaborate and share information during the merger process 1100. In particular, FIG. 13 shows an interface 2000 for a stakeholder user 1142 in the procurement task force. The procurement task force tab 1208 presents the user 1142 with a menu of views, including a view 2015 for sharing objects with stakeholders in the procurement task force. The interface 2000 facilitates collaboration by presenting a view 2035 for the procurement task force stakeholders to share folders 2040 and documents 2070 with stakeholders in the operations task force.

Shared objects can be internal or external. Examples of these externally-generated objects include an Excel® spreadsheet 2080 or a PowerPoint® presentation 2085. The external objects 2080 and 2085 can be generated by software made by Microsoft Corporation.

The stakeholder user 1142 in the procurement task force also can share objects with stakeholders in a merger team 2030. Additionally, the stakeholder user 1142 can view and access other procurement task force team members 2060 and initiate merger actions 2050, such as scheduling a new meeting 2055.

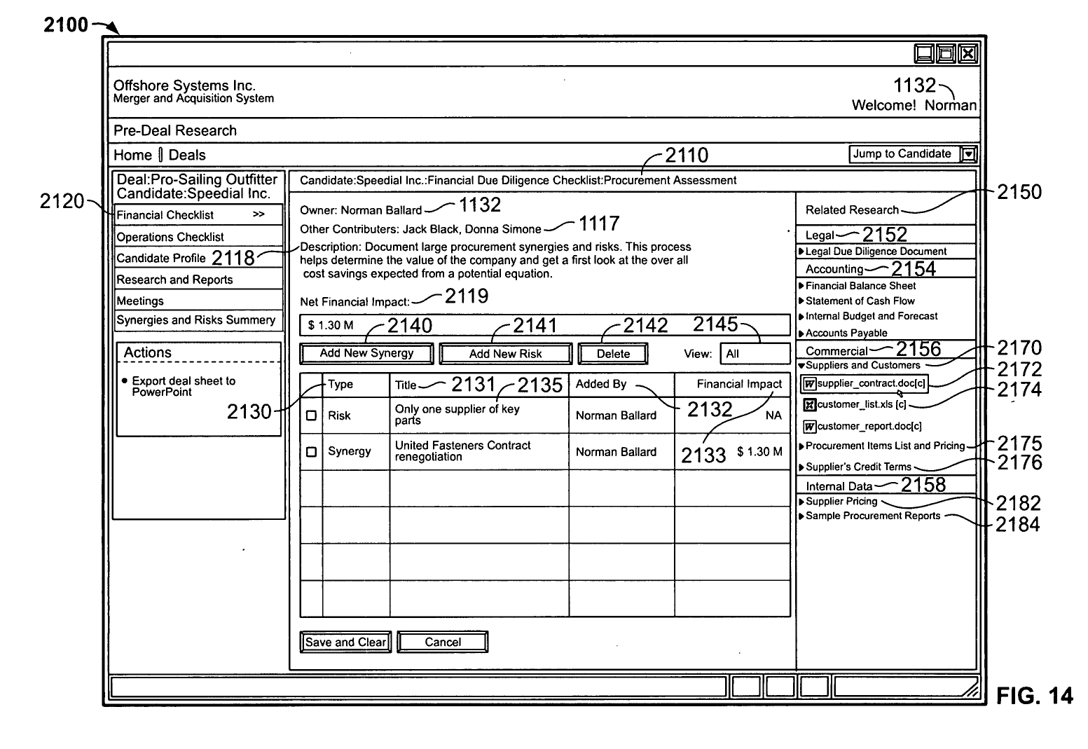

FIG. 14 shows an interface 2100 with a financial checklist 2120 and checklist item 2110. A user 1132 can add a synergy or a risk to the financial checklist 2120 via buttons 2140, 2141. A user 1132 can also delete an item from the checklist 2120 via button 2142. Along with detailed description 2118 of a checklist item 2110, the interface 2100 presents the name of an owner 1132 and other contributors 2117 for the item 2110.

The interface 2100 allows a user 1132 to view (via field 2145) all of the entered risks and synergies by type 2130, title 2131, owner 2132, and financial impact 2133. For instance, the user 1132 can assess a given supplier risk 2135.

The interface 2100 can also present related research 2150 with one or more lists of legal 2152, accounting 2154, commercial 2156, and internal data 2158. The research 2150 can include a variety of procurement information. Some examples of such research 2150 include information on suppliers and customers 2170, supplier contracts 2172, customer lists 2174, procurement items list and pricing 2175, and credit terms for one or more suppliers 2176. Other related research 2150 can include supplier pricing 2182 and sample procurement reports 2184.

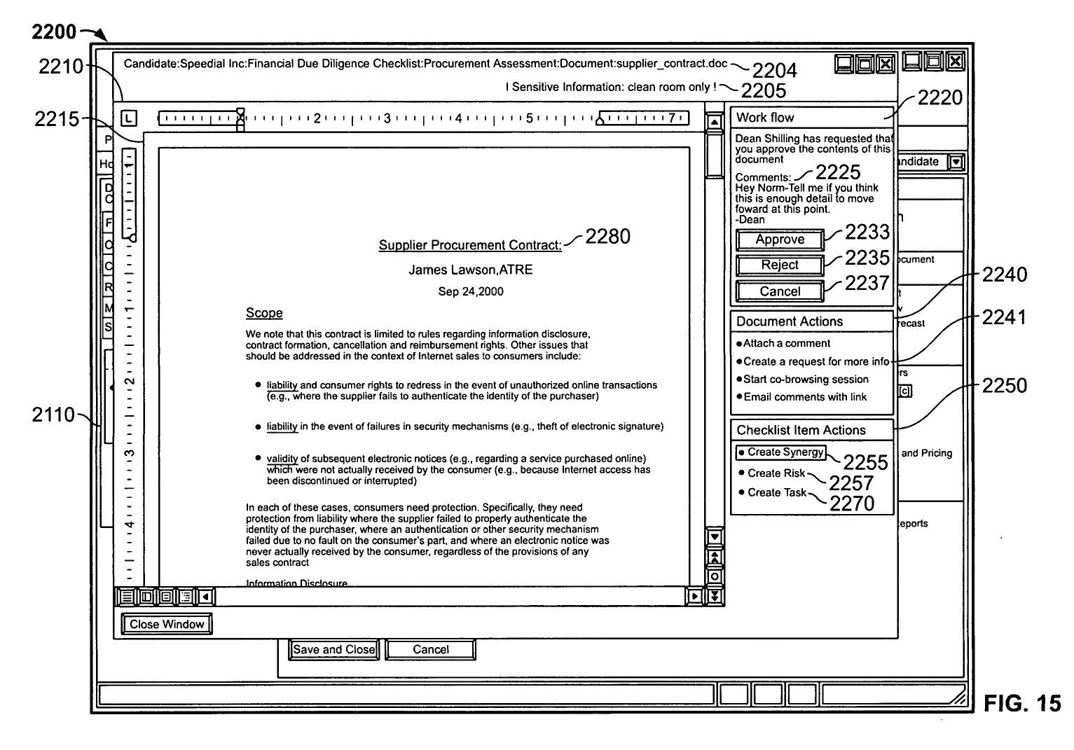

FIG. 15 presents an interface 2200 with a panel 2210 for an object (e.g., a document) 2215 in a merger checklist 220.4. The interface 2200 is presented when a supplier contract document 2172 is selected from interface 2100 (FIG. 14). The supplier procurement contract 2200 can include information for various contract parameters, including legal parameters, financial guidelines, temporal guidelines, strategic goals, and contract objectives. The interface 2200 can identify that the procurement object 2215 includes sensitive information for a clean room participant 2205. The interface 2200 includes a panel 2220 to facilitate merger workflow between stakeholders. The panel 2220 allows a user to easily approve, reject, or cancel a request via buttons 2233, 2235, 2237. The panel 2220 can include comments 2225 from a stakeholder.

The interface 2200 can include a panel 2240 for one or more document actions, such as creating a request 2241. Furthermore, the interface 2200 can include a checklist item actions panel 2250 to allow a user to generate a synergy 2255, a risk 2257, or a task 2270.

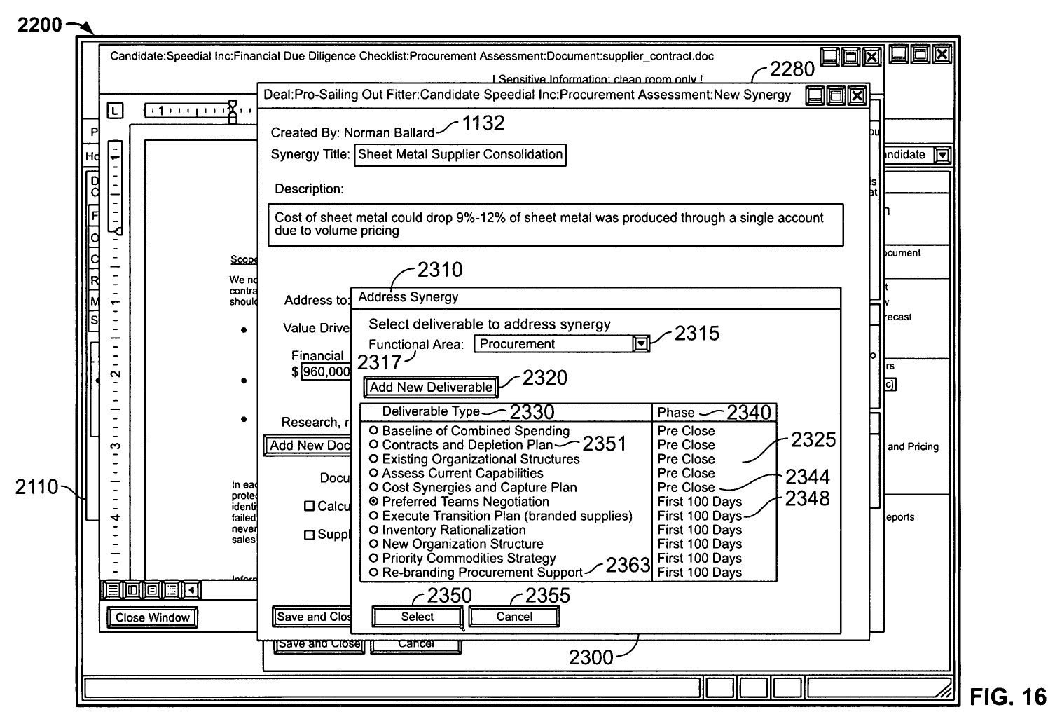

FIG. 16 presents a synergy interface 2300 for a procurement functional area 2315. A user can select the create synergy link 2255 in panel 2250 in FIG. 15 to access a new synergy interface 2280 in FIG. 16. If a user 1132 decides to address a deliverable to a synergy target 2310 in interface 2280 then the interface 2300 can be presented. The interface 2300 allows the user 1132 to select a functional area 2317 for the synergy via pulldown menu field 2315. The user 1132 adds a new deliverable to a list 2325 of deliverables via button 2320. Some examples of listed deliverables include a plan for contracts 2351 and a re-branding of procurement support 2363. The list 2325 can present a deliverable title 2330 and a merger phase 2340 for the deliverable, such as a pre-close phase 2344 or a phase 2348 in the first one hundred days of the merger. The interface 2300 allows the user 1132 to submit or cancel selected deliverables to address synergy 2310 via buttons 2350, 2355.

Other embodiments can be within the scope of the following claims.

What is claimed is:

1. A method of facilitating an enterprise change comprising:
treating two or more information systems as a single logical information system to execute pre-change due diligence and post-change integration of the enterprise change, the enterprise change comprising at least one of a merger and an acquisition; and
providing a user interface to access the logical information system to manage supplier information and supplier resources.

2. The method of claim 1, further comprising:
providing a procurement user interface to access the logical information system to manage procurement information and resources; and
allowing the procurement user interface to present at least one of a synergies panel, a merger risk, a synergy target, and a sub-deliverable, the procurement user interface presenting an impact of a synergy and a risk level impact.

3. An article comprising a machine-readable medium storing instructions operable to cause one or more machines to perform operations comprising:
identifying sources of supplier spending in a merger of at least two organizations, wherein the identifying sources of supplier spending comprises displaying sources of supplier spending in a user interface;
identifying supplier resource spending for at least one of the organizations; and
facilitating supplier consolidation of at least one of the organizations, wherein the facilitating comprises displaying a list of suppliers in the user interface; and
creating an initiative based on the consolidation.

4. The article of claim 3, wherein creating the initiative comprises displaying a menu, wherein the menu comprises basic data, a plurality of actions, a budget, and one or more merger-related resources.

5. A system for planning a merger of at least two organizations, the system comprising a clean room object and a module to consolidate suppliers of at least one of the organizations, the system further comprising a list of consolidated items, the list comprising a lowest negotiated supplier price and a resulting post-merger cost savings.

6. The system of claim 5, wherein the system further comprises at least one of a list of consolidated items with volume information and a list of consolidated suppliers with volume information, at least one of the lists presenting a percent change in volume.

7. A system for planning a merger of at least two organizations, the system comprising a process adapted to allow one or more merger members to access procurement information, the process comprising a user interface adapted to allow a user to search for stakeholders, a deliverables view, and a financial impact of obtaining one or more goods from a supplier.

8. The system of claim 7, in which the process further comprises a planned timeline and a risk level, the process presenting merger financial information, the financial information comprising a budget and a return on investment, the deliverables view comprising one or more sub-deliverables, the system further comprising one or more procurement-related messages, the messages comprising supplier contract information.

9. A method comprising:
facilitating consolidation of suppliers for an organization in a merger of at least two organizations;
facilitating an assessment of supplier information of at least one of the organizations; and
presenting a user interface adapted to facilitate the consolidation of the suppliers and facilitate the assessment of supplier information, the user interface comprising personalized tasks.

10. A system for planning a merger of at least two organizations comprises:
a procurement synergy;
a procurement initiative item related to the procurement synergy; and
an attachment related to the item, the attachment being a supply-related clean-room object.

11. A system for implementing a merger of at least two organizations, wherein the system comprises:
a first user interface adapted for a procurement stakeholder for a first organization; and
a second user interface adapted for a procurement stakeholder for a second organization, the second user interface facilitating sharing of one or more procurement objects with the first user interface.

12. The computer system of claim 11, wherein at least one of the interfaces presents contact information for at least one procurement stakeholder of one of the organizations, the system further comprising a synergy item.

13. A system for planning a merger of at least two organizations, the system comprising information repositories, a clean room, and an interface adapted to present research information, the research information including one or more lists of legal, accounting, commercial, and internal data.

14. The system of claim 13, further comprising at least one of information on suppliers and customers, supplier contracts, customer lists, procurement item lists, credit terms for one or more supplier, supplier prices, and sample procurement reports.

15. The system of claim 13, further comprising a supplier contract document.
